(19) United States
(12) Patent Application Publication
(10) Pub. No.: US 2015/0091782 A1
(43) Pub. Date: Apr. 2, 2015

(54) Display Device for Vehicle

(71) Applicant: Hitachi Construction Machinery Co., Ltd., Tokyo (JP)

(72) Inventors: Yasuo YAMAZAKI, Inashiki-gun (JP); Masaki YOSHIKAWA, Kasama-shi (JP); Kazuyuki ITO, Ryugasaki-shi (JP)

(21) Appl. No.: 14/499,474

(22) Filed: Sep. 29, 2014

(30) Foreign Application Priority Data
Sep. 30, 2013 (JP) 2013-204771

(51) Int. Cl. G09G 5/37; G06F 9/30

(52) U.S. Cl. CPC G09G 5/37; G06F 9/30025; G09G 2380/10; G09G 2340/145; G09G 2320/08; G09G 2320/10
USPC 345/33

(57) ABSTRACT

A display device includes: a display unit that displays a physical quantity; and a display control unit that causes the display unit to display the physical quantity. The display unit includes a numerical value display part that displays a numerical value of a plurality of digits and a unit display part, in which a plurality of units representing the physical quantity coexist; the numerical value display part has a numerical character segment group representing a numerical character in each of the digits; the unit display part has a plurality of symbol segments representing symbols making up the units; and the display control unit selects one of the units, causes symbol segments that represent a selected unit to be displayed in the unit display part, and causes a numerical value representing the physical quantity corresponding to the selected unit to be displayed in the numerical value display part.

### INCORPORATION BY REFERENCE

The disclosure of the following priority application is herein incorporated by reference: Japanese Patent Application No. 2013-204771 filed Sep. 30, 2013.

### BACKGROUND OF THE INVENTION

1. Field of the Invention

The present invention relates to a display device for a vehicle.

2. Description of Related Art

A display device for a vehicle that has a numerical value display unit that displays a plural-digit number and a decimal point and that displays, on the numerical value display unit, engine rotation speed and accumulated operating time in succession (JP 2011-217691 A). In the display device described in JP 2011-217691 A, since the engine rotation speed or the accumulated operating time can be displayed on the numerical value display unit in succession, it is unnecessary to provide a numerical value display unit for engine rotation speed and a numerical value display unit for accumulated operating time separately.

### SUMMARY OF THE INVENTION

However, in such a display device for a vehicle, it is necessary to provide a unit display part for engine rotation speed and a unit display part for accumulated operating time separately. As a result, an increased display area is required accordingly.

According to the 1st aspect of the present invention, a display device for a vehicle, comprises: a display unit that displays at least one kind of physical quantity; and a display control unit that causes the display unit to display the at least one kind of physical quantity, wherein: the display unit includes a numerical value display part that displays a numerical value of a plurality of digits and a unit display part, in which a plurality of units representing the at least one kind of physical quantity coexist; the numerical value display part has a numerical character segment group representing a numerical character in each of the plurality of digits; the unit display part has a plurality of symbol segments representing symbols making up the plurality of units; and the display control unit selects one of the plurality of units, causes symbol segments that represent a selected unit to be displayed in the unit display part, and causes a numerical value representing the at least one kind of physical quantity corresponding to the selected unit to be displayed in the numerical value display part.

According to the 2nd aspect of the present invention, in the display device for a vehicle according to the 1st aspect, it is preferred that the display control unit causes one unit to be displayed as another unit that is different from the one unit by using in common one or more of the plurality of symbol segments in the unit display part.

According to the 3rd aspect of the present invention, in the display device for a vehicle according to the 1st or 2nd aspect, it is preferred that: the display device further comprises a changeover switch for switching over one unit that is displayed in the unit display part to another unit that is different from the one unit; and when the one unit is displayed in the unit display part and if the changeover switch is operated, the display control unit causes the one unit displayed in the unit display part to be changed over to the other unit that is different from the one unit and to be displayed.

According to the 4th aspect of the present invention, in the display device for a vehicle according to the 3rd aspect, it is preferred that: the unit display part is provided for each of a plurality of kinds of physical quantities; the display device further comprises a physical quantity selection switch that selects one physical quantity to be displayed in the display unit out of the plurality of kinds of physical quantities; the display control unit, when the one physical quantity is selected with the physical quantity selection switch, causes a numerical value that represents the selected one physical quantity to be displayed in the numerical value display part and causes a unit that represents the selected one physical quantity to be displayed in the unit display part; in the unit display part, a unit of metric system and a unit of Imperial system coexist; the display control unit has a unit system selection part that sets either one of a metric system mode in which the unit of metric system is displayed in the unit display part and an Imperial system mode in which the unit of Imperial system is displayed in the unit display part in response to an operation of the changeover switch; and in case when either one of the metric system mode or the Imperial system mode is set and if the physical quantity selection switch is operated to change over a display of the display unit from one physical quantity to another physical quantity, the display control unit causes a unit corresponding to a mode set by the unit system selection unit to be displayed in the unit display part.

According to the 5th aspect of the present invention, in the display device for a vehicle according to any one of the 1st to 3rd aspects, it is preferred that: the unit display part is provided for each of a plurality of kinds of physical quantities; and the display control unit causes at least a symbol segment included in one unit display part and a symbol segment included in another unit display part to be displayed in combination to form a unit representing a physical quantity different from a physical quantity represented by each of the one unit display part and the other unit display part.

### BRIEF DESCRIPTION OF THE DRAWINGS

FIG. 1 presents a side view of a wheeled loader as an example of a vehicle;

FIG. 2 presents a diagram showing an outline configuration of the display device for a vehicle;

FIG. 3 presents a diagram showing a monitor;

FIG. 4 presents a diagram showing configurations of a first unit display part and a second unit display part;

FIG. 5 presents a flowchart illustrating operations of display control processing of the monitor;

FIG. 6 presents a flowchart illustrating operations of display processing for displaying physical quantities in the metric system;

FIG. 7 presents a flowchart illustrating operations of display processing for displaying physical quantities in the Imperial system;

FIG. 8A presents a schematic diagram showing a clock display and FIG. 8B presents a schematic diagram showing an accumulated operating time display;

FIGS. 9A and 9B present schematic diagrams, each illustrating a travel distance display;

FIGS. 10A and 10B present schematic diagrams, each illustrating an instant fuel consumption display;

FIGS. 11A and 11B present diagrams, each illustrating an average fuel consumption display;

FIGS. 12A and 12B present schematic diagrams, each illustrating a fuel level display;

FIGS. 13A and 13B present explanatory diagrams of a travel speed display; and

FIG. 14 presents a diagram showing a configuration of a second unit display part in a display device for a vehicle according to a variation example.

### DESCRIPTION OF THE INVENTION

Hereafter, referring to the attached drawings, explanation is made on a display device for a vehicle according to an embodiment of the present invention.

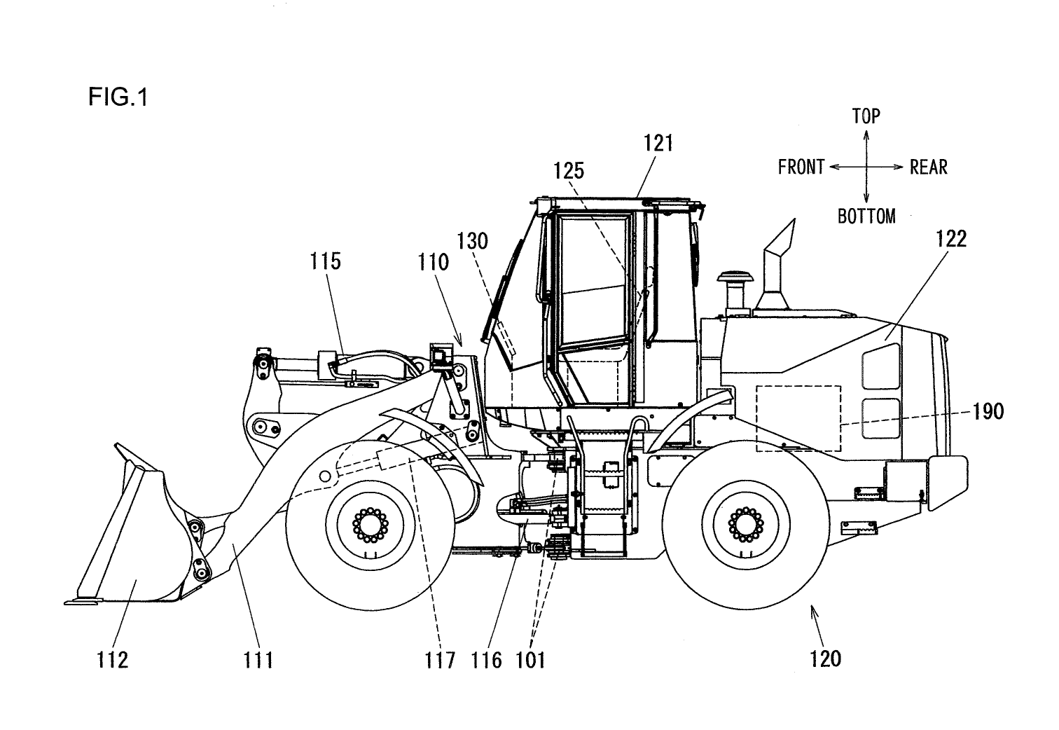

FIG. 1 presents a side view showing a wheeled loader as an example of the vehicle. The wheeled loader includes an arm 111, a bucket 112, and a front body 110 having front wheels, etc., an operator cab 121, a machine room 122, and a rear body 120 having rear wheels, etc.

The arm 111 rotates upwards and downwards (i.e., moving up and down) by being driven by an arm cylinder 117 and the bucket 112 rotates upwards or downwards (i.e., crowd or dump) by being driven by a bucket cylinder 115. The front body 110 and the rear body 120 are rotatably coupled to each other through a center pin 101, with the front body 110 being horizontally bent with respect to the rear body 120 due to extension and retraction of a steering cylinder 116.

In the inside of the machine room 122 is provided an engine 190 and in the inside of the operator cab are provided an operator seat 125 and a monitor 130. The monitor 130 is attached to the operator cab 121 such that the monitor 130 can be seen easily by the operator who sits on the operator seat 125 and that it will not hinder vision of the operator.

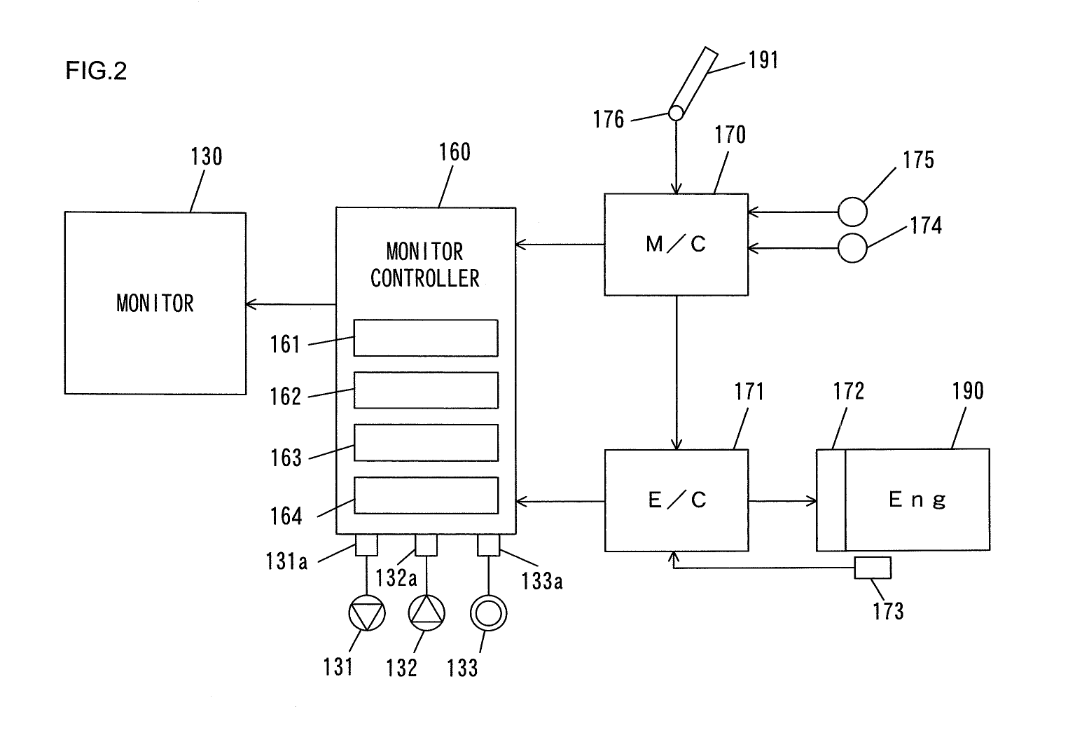

FIG. 2 presents a diagram showing an outline configuration of the display device. The wheeled loader includes a main controller 170, an engine controller 171, and a display device. The display device includes a monitor 130 and a monitor controller 160. The monitor 130 allows display of information about states or conditions of respective parts of the wheeled loader and so on. The configuration of the monitor 130 is described later.

The main controller 170, the engine controller 171, and the monitor controller 160 include each an arithmetic processing unit having a CPU, a storage device such as a ROM and a RAM, peripheral circuits, etc.

The main controller 170 performs control of each unit of the wheeled loader and also calculates vehicle speed and travel distance. The engine controller 171 performs control of a fuel injector 172 and also calculates an instant fuel injection amount and an average fuel injection amount. The monitor controller 160 performs control of a display screen that is displayed on the monitor 130 based on information from various switch signals and physical quantity information that is input and causes the monitor 130 to display one or more predetermined physical quantities.

To the main controller 170 is connected an accelerator operating amount sensor 176, which detects a pedal operating amount (e.g., pedal stroke or pedal angle) of an accelerator pedal 191. The main controller 170 sets a target engine rotation speed of the engine 190 according to the pedal operating amount of the accelerator pedal 191.

The main controller 170 outputs a control signal that corresponds to the set target engine rotation speed to the engine controller 171. To the engine controller 171 is connected a rotation speed sensor 173 that detects actual rotation speed of the engine 190 and outputs an actual rotation speed signal to the engine controller 171. The engine controller 171 controls the fuel injector 172 by comparing the actual rotation speed of the engine 190 detected by the rotation speed sensor 173 with a target engine rotation speed from the main controller 170 and outputting a fuel injection signal to the fuel injector 172 in order to bring the actual rotation speed of the engine 190 closer to the target engine rotation speed.

The main controller 170 has a function of a clock and outputs information about present time to the monitor controller 160. The main controller 170 has a function of a timer and stores operating time of the engine 190 cumulatively, and outputs information about accumulated operating time T to the monitor controller 160. The unit of integrated operating time T is “h (hour)”.

The engine controller 171 calculates an instant fuel consumption Fim and an average fuel consumption Fam based on the fuel injection signal (command value) and outputs information about the instant fuel consumption Fim and average fuel consumption Fam to the monitor controller 160. Units of the instant fuel consumption Fim and the average fuel consumption Fam are each “l/h (liter per hour)”, respectively. The instant fuel consumption is calculated as an amount of fuel injected into the cylinder of the engine 190 for a unit time, for example, 1 second. The average fuel consumption can be obtained by averaging the instant fuel consumption obtained for a predetermined period of time. The average fuel consumption can be obtained, for example, by dividing integrated fuel consumption by the operating time of the engine 190 required for consuming that amount of the fuel. Note that the instant fuel consumption and the average fuel consumption give results different from each other as numerical information since measuring time is different. However, they give the same kind of physical quantity that represents fuel efficiency (fuel consumption rate or gas mileage).

To the main controller 170 is connected a vehicle speed sensor 174, which detects vehicle speed and outputs a vehicle speed signal corresponding to the detected vehicle speed. The vehicle speed signal is input to the main controller 170. The main controller 170 calculates actual vehicle speed of the wheeled loader based on the input vehicle speed signal and outputs the obtained information of actual vehicle speed to the monitor controller 160. Also, the main controller 170 calculates travel distance Lm of the wheeled loader based on the input vehicle speed signal and outputs the obtained information of travel distance Lm to the monitor controller 160. The unit of travel distance Lm is “km (kilometer)”.

To the main controller 170 is connected a fuel level sensor 175, which detects fuel level (residual quantity) and outputs a fuel level signal corresponding to the detected fuel level. The fuel level signal is input to the main controller 170. The fuel level sensor 175 is a liquid level sensor that detects the liquid level of the fuel in the fuel tank (not shown). The main controller 170 calculates the fuel level Frm in the fuel tank (not shown) based on the input fuel level signal and outputs the information of the fuel level Frm to the monitor controller 160. The unit of fuel level Frm is “l (liter)”.

To the monitor controller 160 are input, as mentioned above, various pieces of numerical information, i.e., present time, integrated operating time T, travel distance Lm, and fuel level Frm. from the main controller 170, and numerical information of instant fuel consumption Fim and average fuel consumption Fam from the engine controller 171.

The monitor controller 160 is provided with a signal detection unit 133a that detects a signal from a unit system changeover switch 133, a signal detection unit 131a that detects a signal from a physical quantity selection switch 131, and a signal detection unit 132a that detects a signal from a fuel display changeover switch 132. The monitor controller 160, as described later, performs setting of a unit system mode flag, a physical quantity mode flag, and a fuel mode flag based on the information detected at the signal detection units 133a, 131a, and 132a, respectively.

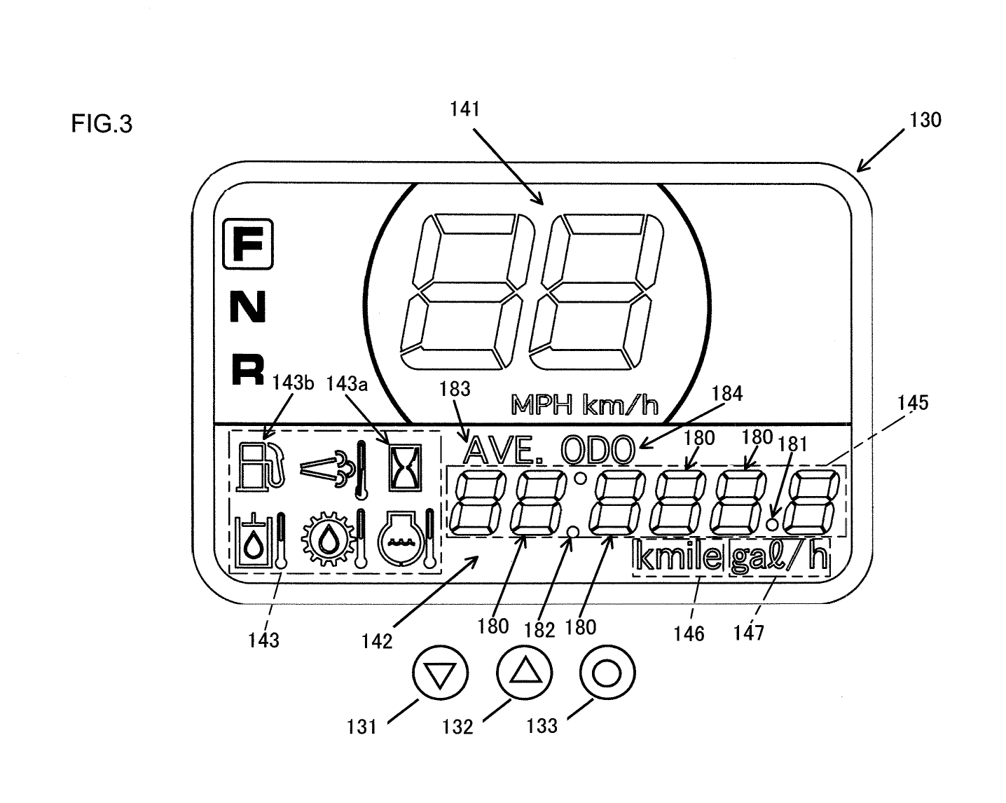

Referring to FIG. 3 the monitor 130 is explained. The monitor 130 is a liquid crystal panel of segmented type, which includes a plurality of segments each having a predetermined shape. The liquid crystal panel of segmented type is inexpensive as compared to a liquid crystal panel of dot-matrix type, so that it contributes to cost reduction of the display device. Each segment is connected to the monitor controller 160. When an ON signal is output to a segment, the segment is turned into a display state, while when an OFF signal is output to a segment, the segment is turned into a non-display state. Herein, the term “segment” means a part that can be independently controlled to be in a display state or in a non-display state.

The monitor 130 has a first display part 141 that is arranged on an upper side as seen from the operator and a second display part 142 that is arranged on a lower side as seen from the operator. In the center of the first display part 141 is provided a speed display part that displays vehicle speed. On the left side in the drawing of the first display part 141 is provided an operating position display part that indicates which one of forward (F), neutral (N) and reverse (R) positions a forward-reverse movement changeover switch (not shown) is operated to.

The second display part 142 has an icon display part 143 arranged on the left side in the drawing, a numerical value display part arranged over a part from the right hand edge of the icon display 143 to the right hand edge of the second display part 142, and a first unit display part 146 and a second unit display part 147 which are arranged on the lower side in the drawing of the numerical value display part 145.

In the icon display part 143, a fuel indicator 143b, a regeneration indicator, and an hourglass indicator 143a are arranged on an upper stage, while an operating oil temperature indicator, a transmission oil temperature indicator, and a cooling water temperature indicator are arranged on a lower stage. Each of the indicators is constituted by 1 segment that is independently controlled to be in a display state or in a non-display state.

In the numerical value display part 145 are arranged numeric character segment groups 180 each representing an Arabic number in a line in a horizontal direction. The numeric character segment groups 180 are provided one for one digit, i.e., in total 6, so that numerical values up to 6 digits can be displayed. Each of the numerical character segment groups 180 is a 7-segment display that is made up by 7 segments and that can represent a symbol such as an Arabic number by bringing predetermined segments into a display state.

Between the rightmost numerical character segment group 180 and next to the rightmost numerical character segment group 180 is provided a dot segment 181, so that numerical values down to one decimal place can be displayed. Between the next to the leftmost numerical character segment group 180 and the third to the leftmost numerical character segment 180 is provided a colon segment 182, so that time (time of day) and time period can be displayed.

On the upper side in the drawing of the numerical display part 145 are arranged an average value indicator 183 and an odo indicator 184. The average value indicator 183 is a segment that represents the character of “AVE.” indicating that the information represented by the numerical value display part 145 is an average value. The odo indicator 184 is a segment that represents the character of “ODO” indicating that the information represented by the numerical value display part 145 is a travel distance.

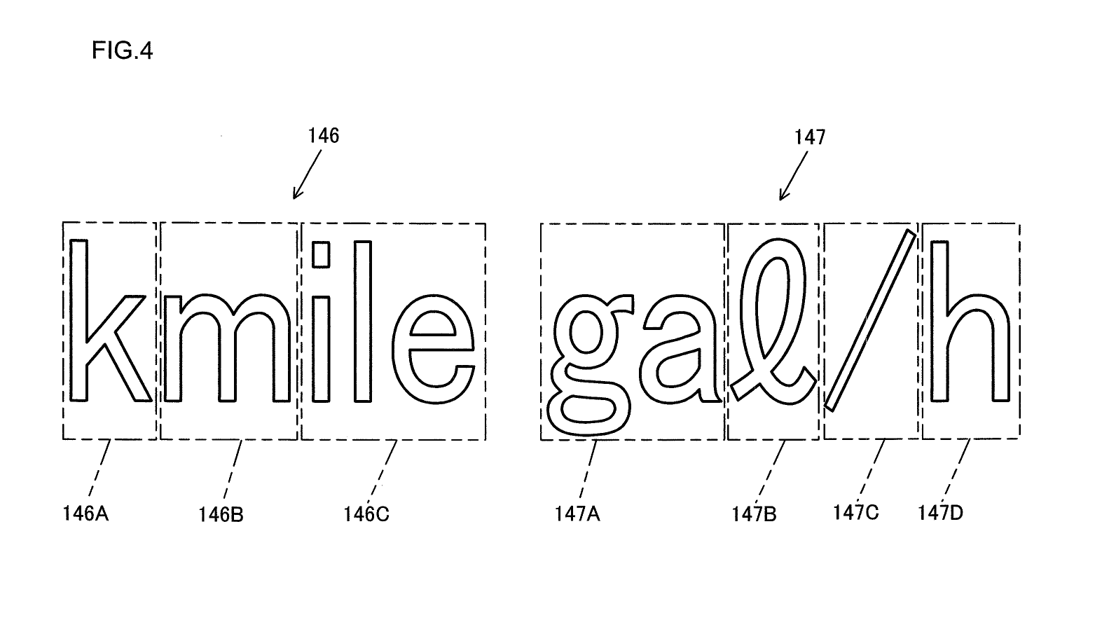

FIG. 4 presents a diagram showing the respective configurations of the first unit display part 146 and the second unit display part 147. The first display part 146 and the second unit display part 147 are arranged side by side horizontally. The first unit display part 146 has a first A segment 146A, which is a symbol segment that represents “k” and a first B segment 146B, which is a symbol segment that represents “m”, and a first C segment 146C, which is a symbol segment that represents “ile”. The first unit display part 146 has a mixed configuration in which “km (kilometer)” which is a unit of the metric system representing a travel distance and “mile (mile)” which is a unit of the Imperial system (yard-pound system) representing a travel distance coexist. That is, three symbol segments are used for one and the same physical quantity (distance), with one symbol segment (symbol “m”), which is used in common, and one symbol segment selected from the other two symbol segments (either symbol “k” or symbol “ile”) being combined with each other, so that two different unit systems can be displayed.

Specifically, this is done as follows.

By displaying the symbol segment 146B, which represents “m” and the symbol segment 146A, which represents “k”, in combination, “km”, which is a unit of travel distance according to the metric system, can be formed. By displaying the symbol segment 146B, which represents “m” and the symbol segment 146C, which represents “ile”, in combination, “mile”, which is a unit of travel distance according to the Imperial system, can be formed.

The second unit display part 147 has a second A segment 147A, which is a symbol segment that represents “ga”, and a second B segment 147B, which is a symbol segment that represents “l”, and a second C segment 147C, which is a symbol segment that represents “/(slash)”, and a second D segment 147D, which is a symbol segment that represents “h”. The second display part 147 has a mixed configuration in which “l (liter)”, which is a unit of the metric system representing fuel level, “gal (galon)”, which is a unit of the Imperial system representing fuel level, “l/h (liter per hour)”, which is a unit of the metric system representing fuel consumption, and “gal/h (galon per hour)”, which is a unit of the Imperial system representing fuel consumption, and “h (hour)”, which is a unit representing time period coexist.

That is, four symbol segments are used for three different physical quantities (i.e., fuel efficiency, fuel amount, and time period). One of these is selected and used (“l” or “h”), or one symbol segment (symbol “l”) is used in common and 1 to 3 of other three symbol segments are selected and combined to display two physical quantities (fuel efficiency and fuel amount), or two unit systems (the metric system and the Imperial system) are displayed for the displayed physical quantity.

Specifically, this is done as follows.

By displaying only one symbol segment 147D, which represents “h”, unit of time period can be represented.

By displaying only one symbol segment 147B, which represents “l”, a unit of the metric system of fuel level can be represented. By displaying the symbol segment 147B, which represents “l” and the symbol segment 147A, which represents “ga”, in combination, “gal”, which is a unit of the Imperial system of fuel level, can be formed.

By displaying the symbol segment 147B, which represents “l” and the two symbol segments 147C and 147D, which represent “/” and “h”, respectively, in combination, “l/h”, which is a unit of the metric system of fuel consumption, can be formed. By displaying the symbol segment 147B, which represents “l” and the three symbol segments 147A, 147C, and 147D, which represent “gal”, “/”, and “h”, respectively, in combination, “gal/h”, which is a unit of the Imperial system of fuel consumption, can be formed.

The first A segment 146A, the first B segment 146B, and the first C segment 146C as well as the second A segment 147A, the second B segment 147B, and the second D segment 147D are symbol segments made up by English characters, respectively. The second C segment 147C is a symbol segment made up by a slash mark. As described above, the first unit display part 146 and the second unit display part 147 are made up by the symbol segments 146A to 146C making up a plurality of units and the symbol segments 147A to 147D making up a plurality of units, respectively.

As shown in FIG. 3, below the monitor 130 are arranged the physical quantity selection switch 131, the fuel display changeover switch 132, and the unit system changeover switch 133. The switches 131, 132, and 133 are each a so-called momentary switch, which is turned on by a push operation and turned off by non-operation. That is, the switches 131, 132, and 133 output each an ON signal to the monitor controller 160 each time when a push operation is performed.

The physical quantity selection switch 131 is an operation switch for changing over the content of the physical quantity that is displayed on the second display part 142. In other words, the physical quantity selection switch 131 is an operation switch for selecting one physical quantity that is to be displayed on the second display part 142 out of a plurality of kinds of physical quantities (i.e., time, fuel efficiency, fuel amount, and time period). The fuel display changeover switch 132 is an operation switch for changing over information about fuel consumption to be displayed on the second display part 142, between information of instant fuel consumption or information of average fuel consumption.

The unit system changeover switch 133 is an operation switch for changing over a unit of the metric system (or the Imperial system) displayed on any of the first unit display part 146 and the second unit display part 147 to a unit of the Imperial system (or the metric system) which is a different unit system. Note that according to changeover of unit, the numerical value is changed over to one that corresponds to the unit that is changed over. For this purpose, the unit system changeover switch 133 also is an operation switch for changing over the numerical value content displayed in the numerical value display part 145 from a numerical value according to the unit of the metric system (or the Imperial system) to a numerical value according to the unit of the Imperial system (or the metric system).

As shown in FIG. 2, the monitor controller 160 functionally includes a physical quantity selection part 161, a unit system selection part 162, a calculation part 163, and a segment display control part 164. The physical quantity selection part 161 selects information about a physical quantity to be displayed in the second display part 142 in response to operation signals from the physical quantity selection switch 131 and the fuel display changeover switch 132, respectively. The unit system selection part 162 selects a unit system of a numerical value and a unit to be displayed in the second display part 142 in response to an operation signal from the unit system changeover switch 133. The calculation part 163 converts a numerical value of the metric unit system to a numerical value of the Imperial unit system when the Imperial unit system is selected in the unit system selection part 162. The segment display control part 164 controls a display/non-display state of each segment for causing the numerical value and unit that represent the physical quantity selected in the physical quantity selection part 161 to be displayed in the unit system selected in the unit system selection part 162.

The physical quantity selection part 161 performs setting of a physical quantity mode flag based on the operation signal from the physical quantity selection switch 131 that is detected by the signal detection unit 131a.

The physical quantity mode flag is stored in the storage device of the monitor controller 160. The physical quantity mode flag is set to “1” when the physical quantity selection switch 131 is operated in a state where the physical quantity mode flag is “0”. The physical quantity mode flag is set to “2” when the physical quantity changeover switch 131 is operated in a state where the physical quantity mode flag is “1”. The physical quantity mode flag is set to “3” when the physical quantity changeover switch 131 is operated in a state where the physical quantity mode flag is “2”. The physical quantity mode flag is set to “4” when the physical quantity changeover switch 131 is operated in a state where the physical quantity mode flag is “3”, and the physical quantity mode flag is set to “0” when the physical quantity changeover switch 131 is operated in a state where the physical quantity mode flag is “4”.

A mode in which the physical quantity mode flag is set to “0” is defined to be a clock display mode, a mode in which the physical quantity mode flag is set to “1” is defined to be an accumulated operating time display mode, and a mode in which the physical quantity mode flag is set to “2” is defined to be a travel distance display mode. A mode in which the physical quantity mode flag is set to “3” is defined to be a fuel consumption display mode, and a mode in which the physical quantity mode flag is set to “4” is defined to be a fuel level display mode. That is, each time when the operator pushes the physical quantity selection switch 131, the physical quantity display mode is changed over in the order of the clock display mode, the accumulated operating time display mode, the travel distance display mode, the fuel consumption display mode, and the fuel level display mode.

The physical quantity selection part 161 performs setting of the fuel mode flag based on an operation signal from the fuel display changeover switch 132 detected at the signal detection part 132a.

The fuel mode flag is stored in the storage device of the monitor controller 160 and when the fuel display changeover switch 132 is operated in a state where the fuel mode flag is “0”, the fuel mode flag is set to “1”. The fuel mode flag is set to “0” when the fuel display changeover switch 132 is operated in a state where the fuel mode flag is “1”. A mode in which the fuel mode flag is set to “0” is defined to be an instant fuel consumption mode while a mode in which the fuel mode flag is set to “1” is defined to be an average fuel consumption mode. That is, each time when the operator pushes the fuel display changeover switch 132, the fuel consumption display mode is changed over between an instant fuel consumption mode and an average fuel consumption mode.

The unit system selection part 162 performs setting of a unit system mode flag in response to an operation signal from the unit system changeover switch 133 detected in the signal detection part 133a.

The unit system mode flag is stored in the storage device of the monitor controller 160. The unit system mode flag is set to “1” when the unit system changeover switch 133 is operated in a state where the unit system mode flag is “0” and the physical quantity mode flag is set to any one of “2”, “3”, and “4”. The unit system mode flag is set to “0” when the unit system changeover switch 133 is operated in a state where the unit system mode flag is “1” and the physical quantity mode flag is set to any one of “2”, “3”, and “4”. A mode in which the unit system mode flag is set to “0” is defined to be the metric system mode, while a mode in which the unit system mode flag is set to “1” is defined to be the Imperial system mode. That is, when a numerical value and a unit of any one of travel distance, instant fuel consumption, average fuel consumption, and fuel level are displayed in the second display part 142 and the unit system changeover switch 133 is operated, the monitor controller 160 causes the numerical value and the unit of the displayed physical quantity to be displayed with the unit system being changed over to a unit system that is different from the displayed unit system.

As described above, the unit system selection part 162 selects one of the metric unit system and the Imperial unit system based on an operation signal from the unit system changeover switch 133. As a result, each time when the operator pushes the unit system changeover switch 133, the unit system mode is changed over between the metric system mode and the Imperial system mode. In the metric system mode, a numerical value and a unit expressed in the metric system are displayed in the second display part 142. In the Imperial system mode, a numerical value and a unit expressed in the Imperial system are displayed in the second display part 142.

The calculation part 163 multiplies numerical information in the metric system that is input from the main controller 170 and the engine controller 171 by a predetermined coefficient to convert the numerical information into an equivalent numerical value in the Imperial system.

When a physical quantity is selected from a plurality of kinds of physical quantities by the physical quantity selection part 161 and a unit system is selected from a plurality of unit systems by the unit system selection part 162, the segment display control part 164 causes the numerical value and unit of the selected physical quantity to be displayed in the selected unit system. The segment display control part 164 forms a predetermined numerical value by controlling predetermined segments that make up each numerical segment group 180 in the numerical value display part 145 to be in a display state and other segments than the predetermined symbol segments to be in a non-display state. The segment display control part 164 forms a predetermined unit by controlling predetermined symbol segments in the first unit display part 146 and the second unit display part 147 to be in a display state and other symbol segments than the predetermined symbol segments to be in a non-display state.

When a clock display mode is set, the segment display control part 164 causes a numerical value representing present time and the colon segment 182 to be displayed in the numerical value display part 145 and causes the colon segment 182 to be displayed blinking once a second.

When an accumulated operating time display mode is set, the segment display control part 164 causes a numerical value representing an accumulated operating time to be displayed in the numerical value display part 145 and causes the unit “h” representing the accumulated operating time to be displayed in the second unit display part 147.

When a travel distance display mode is set, the segment display control part 164 causes “ODO” to be displayed in the odo indicator 184 and a numerical value representing a travel distance to be displayed in the numerical value display part 145, and causes the unit “km” or “mile” representing a travel distance to be displayed in the first unit display part 146.

When an instant fuel consumption mode is set, the segment display control part 164 causes a numerical value representing an instant fuel consumption to be displayed in the numerical value display part 145 and the unit “l/h” or “gal/h” representing the instant fuel consumption to be displayed in the second unit display part 147.

When an average fuel consumption mode is set, the segment display control part 164 causes “AVE.” to be displayed in the average value indicator 183, causes a numerical value representing an average fuel consumption to be displayed in the numerical value display part 145, and causes the unit “l/h” or “gal/h” representing the average fuel consumption to be displayed in the second unit display part 147.

When a fuel level display mode is set, the segment display control part 164 causes a numerical value representing fuel level to be displayed in the numerical value display part 145 and causes the unit “l” or “gal” representing the fuel level to be displayed in the second unit display part 147.

When a metric system mode is set, the segment display control part 164 causes numerical values input from the main controller 170 and the engine controller 171, i.e., numerical values corresponding to the unit of the metric unit system to be displayed in the numerical value display part 145. When a metric system mode is set, the segment display control part 164 causes the unit of the metric unit system to be displayed in the first unit display part 146 or the second unit display part 147.

When an Imperial system mode is set, the segment display control part 164 causes a numerical value whose unit is converted in the calculation part 163, that is, a numerical value that corresponds to the unit of the Imperial unit system to be displayed in the numerical value display part 145. When an Imperial system mode is set, the segment display control part 164 causes the unit of the Imperial unit system to be displayed in the first unit display part 146 or the second unit display part 147.

Note that in an initial state, respective flags (physical quantity mode flag, fuel mode flag, and unit system mode flag) are set to “0”. The respective flags that are set in response to operation signals from the switches 131, 132, and 133 are stored in the storage device. When an ignition switch is turned off (is operated to an OFF position) and thereafter the ignition switch is turned ON (i.e., is operated to any one of a start position, an ON position, and an ACC position), only the unit system flag maintains its set state, whereas the physical quantity mode flag and the fuel mode flag are returned to their respective initial states.

The respective flags (physical quantity mode flag, fuel mode flag, and unit system mode flag) are set only with the corresponding switches 131, 132, and 133. For example, even when the physical quantity mode flag is changed from “2” to “3” in a state where the unit system mode flag is set to “0”, the unit system mode flag remains to be “0”. That is, when the physical quantity selection switch 131 or the fuel display changeover switch 132 is operated in a state where the metric system mode is set, the physical quantity to be changed is displayed in the metric unit system.

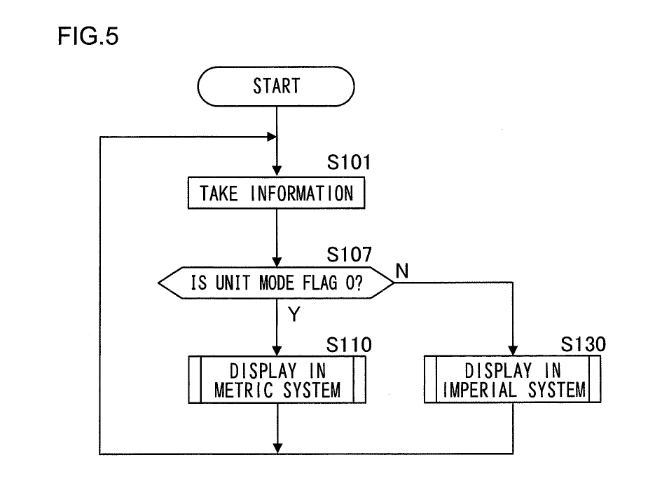

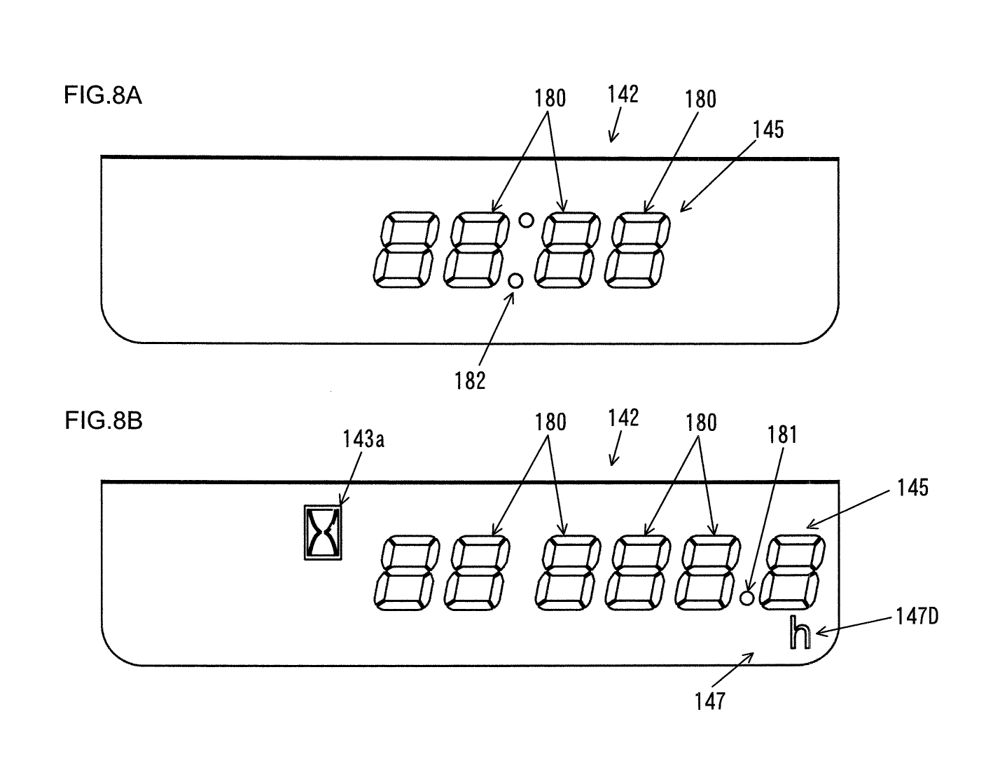

Hereafter, operations of the display control processing of the monitor 130 by the monitor controller 160 are explained referring to the flowcharts in FIGS. 5 to 7. FIGS. 8A to 12B present schematic diagrams showing the second display part 142, display states and non-display states of which are controlled according to the processing illustrated in FIGS. 5 to 7. Note that in the second display part 142, segments in a display state are shown but segments in a non-display state are not shown. The numerical value display part 145 shows the numerical character segment group 180 that can be converted into a display state. Each of the segments that make up the numerical character segment group 180 is controlled for its display/non-display state separately to display a numerical value that represents a physical quantity.

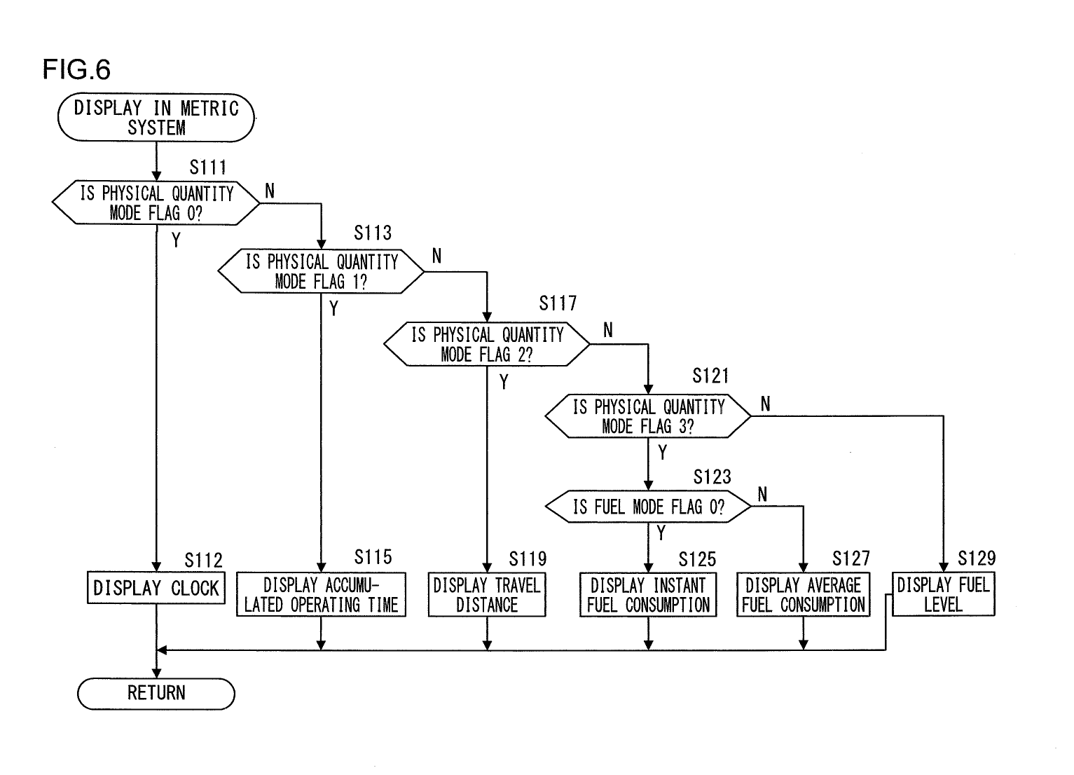

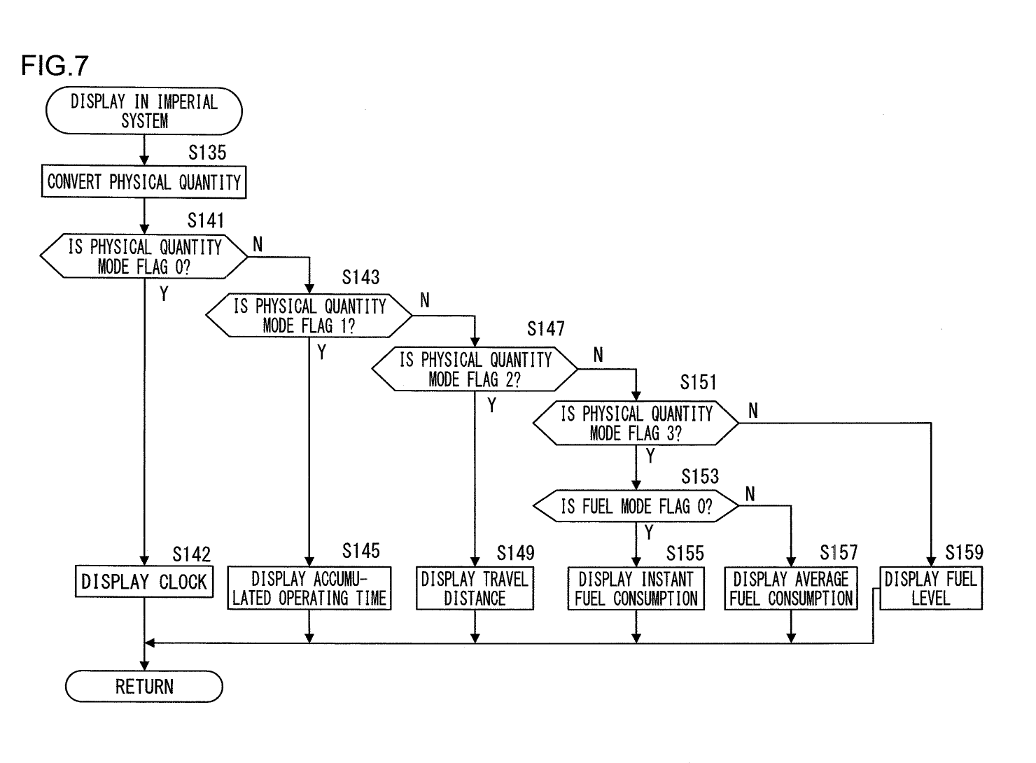

FIG. 5 presents a flowchart illustrating operations of the display control processing of the monitor 130. FIG. 6 presents a flowchart illustrating operations of the processing in which a physical quantity is displayed in the metric system. FIG. 7 presents a flowchart illustrating operations of the processing in which a physical quantity is displayed in the Imperial system. When an ignition switch (not shown) is turned ON, a program that performs the processing illustrated in FIG. 5 is started up and repeatedly executed in the monitor controller 160. Note that hereafter, display control processing for the second display part 142 is explained. However, explanations are omitted with respect to the contents of controls of the display control processing for the first display part 141 and the contents of controls for a regeneration indicator, an operating oil temperature indicator, a transmission oil indicator, and a cold water temperature indicator.

In step S101, the monitor controller 160 takes various kinds of information including present time, accumulated operating time T, travel distance Lm, instant fuel consumption Fim, average fuel consumption Fam, and fuel level Frm, and the program proceeds to step S107. The pieces of information about present time, accumulated operating time T, and travel distance Lm are output from the main controller 170 and the pieces of information about the instant fuel consumption Fim and the average fuel consumption Fam are output from the engine controller 171. All the pieces of information are output as numerical information in the metric unit system.

In step S107, the monitor controller 160 judges whether or not the unit system mode flag is 0. If a positive judgment is made in step S107, the program proceeds to step S110, while if a negative judgment is made, the program proceeds to step S130.

In step S110, the monitor controller 160 executes metric system unit display processing by which display of various kinds of physical quantities is controlled according to the metric system. As shown in FIG. 6, in step S111, the monitor controller 160 judges whether or not the physical quantity mode flag is 0. If a positive judgment is made in step S111, the program proceeds to step S112, while if a negative judgment is made in step S111, the program proceeds to step S113.

In step S112, the monitor controller 160 outputs an ON signal to each of predetermined segments in the numerical character segment group 180 and the colon segment 182 in the numerical value display part 145 based on the information about the present time, and the program returns to step S101. The display screen of the second display part 142 is expressed as shown in FIG. 8A.

In step S113, the monitor controller 160 judges whether or not the physical quantity mode flag is 1. If a positive judgment is made in step S113, the program proceeds to step S115, while if a negative judgment is made in step S113, the program proceeds to step S117.

In step S115, the monitor controller 160 outputs an ON signal to each of the hourglass indictor 143a and the second D segment 147D. Furthermore, the monitor controller 160 outputs an ON signal to each of predetermined segments of the numerical character segment group 180 and the dot segment 181 in the numerical value display part 145 based on the information of the accumulated operating time T [h] and the program returns to step S101. The display screen of the second display part 142 is expressed as shown in FIG. 8B.

In step S117, the monitor controller 160 judges whether or not the physical quantity mode flag is 2. If a positive judgment is made in S117, the program proceeds to step S119, while if a negative judgment is made in step S119, the program proceeds to step S121.

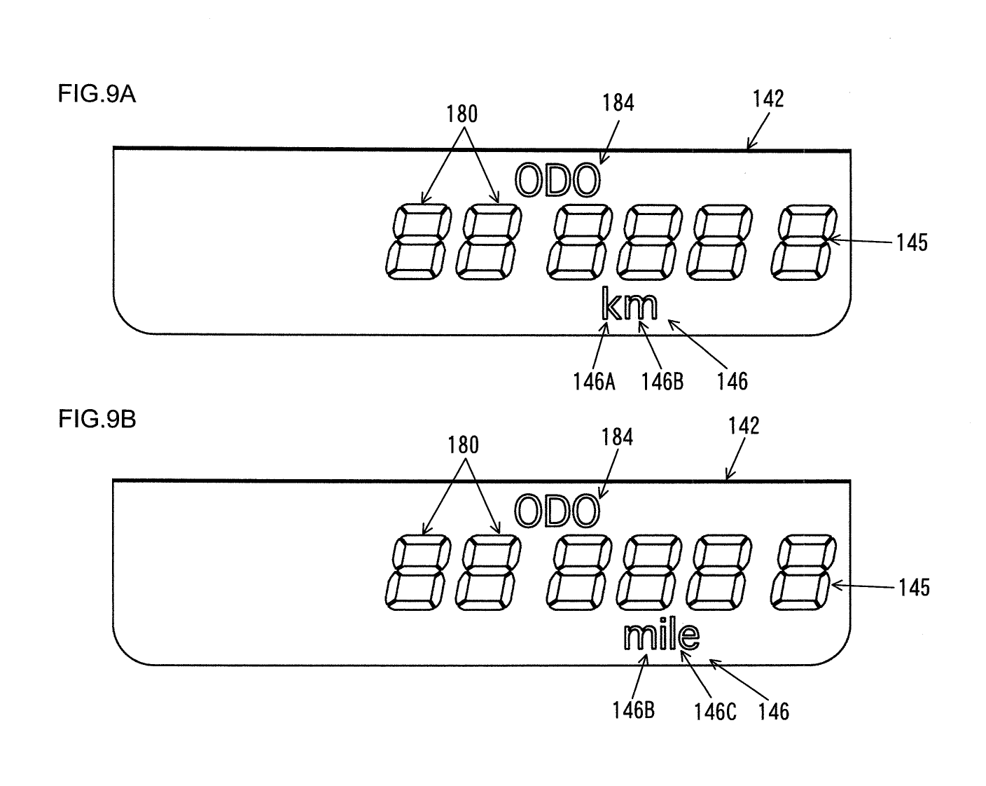

In step S119, the monitor controller 160 outputs an ON signal to the odo indicator 184 and to each of the first A segment 146A and the first B segment 146B. Furthermore, the monitor controller 160 outputs an ON signal to predetermined segments of the numerical character segment group 180 in the numerical value display part 145, and the process returns to step S101. The display screen of the second display part 142 is expressed as shown in FIG. 9A.

In step S121, the monitor controller 160 judges whether or not the physical quantity mode flag is 3. If a positive judgment is made in step S121, the program proceeds to step S123, while if a negative judgment is made in step S121, the program proceeds to step 129.

In step S123, the monitor controller 160 judges whether or not the fuel mode flag is 0. If a positive judgment is made in step S123, the program proceeds to step S125, while if a negative judgment is made in step S123, the program proceeds to step S127.

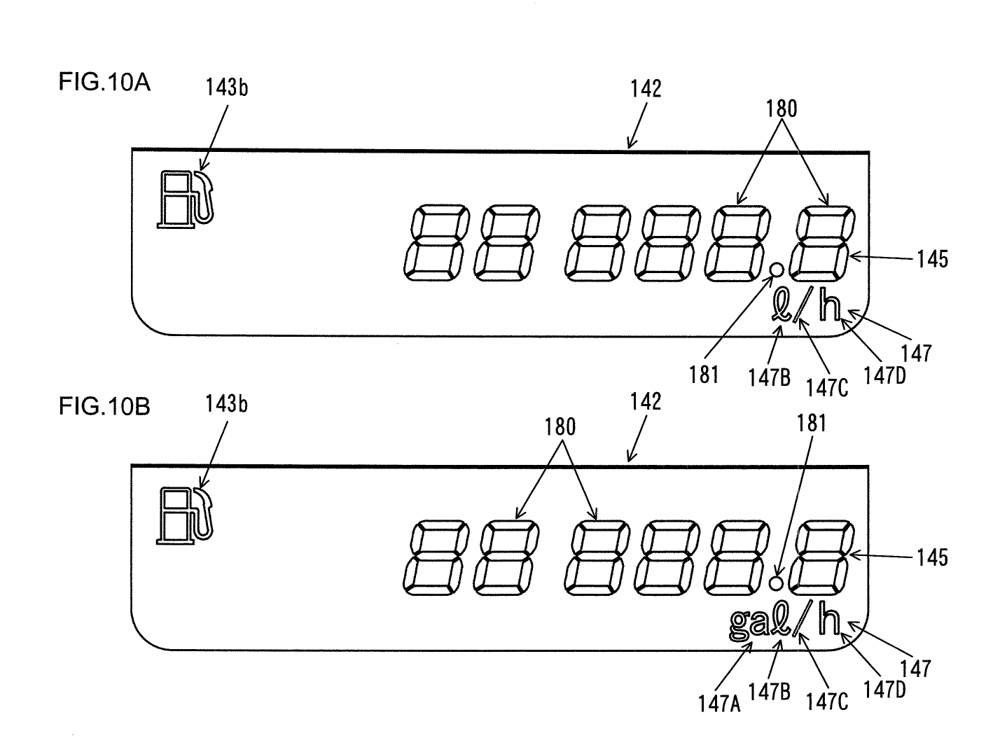

In step S125, the monitor controller 160 outputs an ON signal to the fuel indicator 143b and to each of the second B segment 147B, the second C segment 147C, and the second D segment 147D. Furthermore, the monitor controller 160 outputs an ON signal to predetermined segments of the numerical character segment group 180 and to the dot segment 181 in the numerical display part 45 based on the information of the instant fuel consumption Fim [l/h] taken in step S101. Then, the program returns to step S101. The display screen of the second display part 142 is expressed as shown in FIG. 10A.

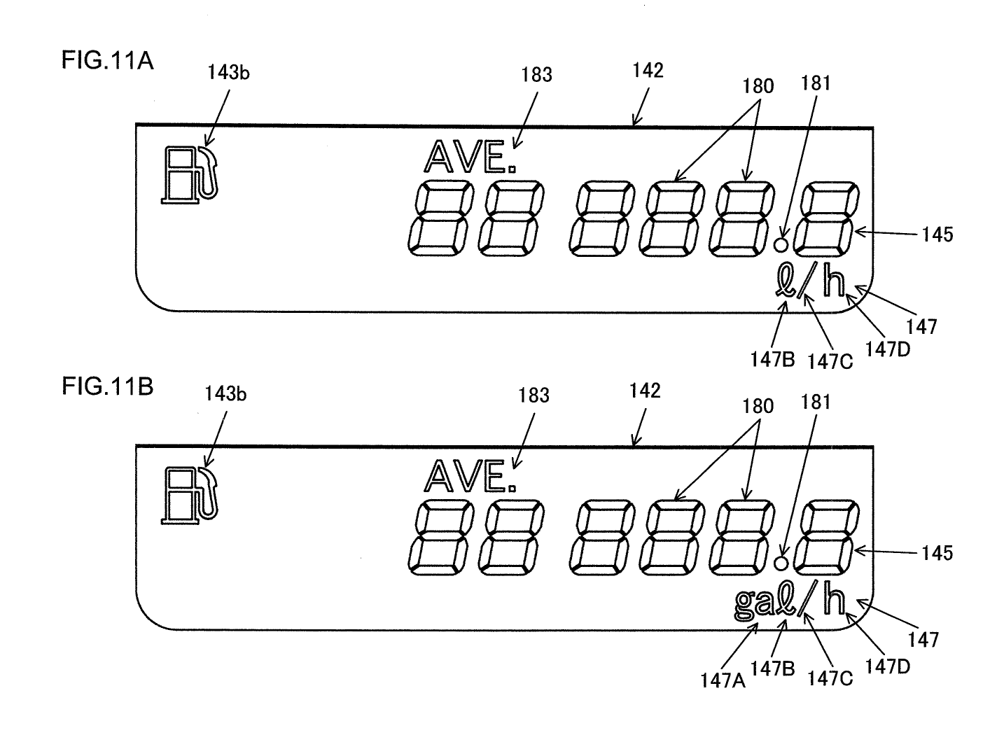

In step S127, the monitor controller 160 outputs an ON signal to each of the fuel indicator 143b, the average indicator 183, and the second B segment 147B, the second C segment 147C, and the second D segment 147D. Furthermore, the monitor controller 160 outputs an ON signal to predetermined segments of the numerical character segment group 180 and to the dot segment 181 in the numerical value display part 145 based on the information of the average fuel consumption Fam [l/h] taken in step S101. Then, the program returns to step S101. The display screen of the second display part 142 is expressed as shown in FIG. 11A.

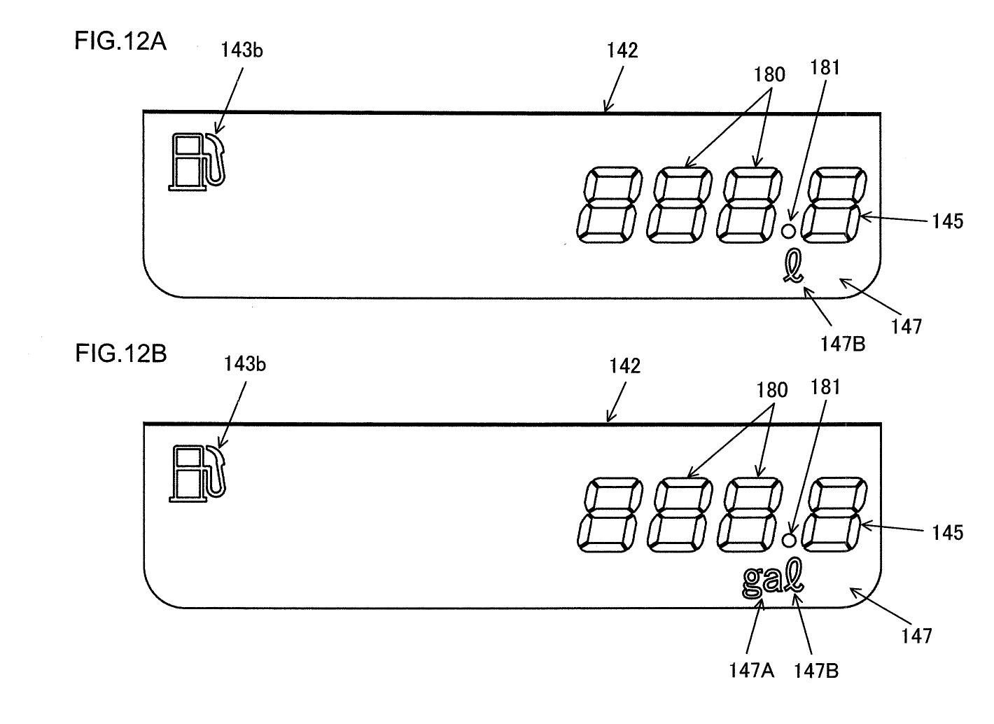

In step S129, the monitor controller 160 outputs an ON signal to each of the fuel indicator 143b and the second B segment 147B. Furthermore, the monitor controller 160 outputs an ON signal to predetermined segments of the numerical character segment group 180 and to the dot segment 181 in the numerical value display part 145 based on the information about the fuel level Frm [l] taken in step S101. The display screen of the second display part 142 is expressed as shown in FIG. 12A.

If a negative judgment is made in step S107 shown in FIG. 5, that is, if the Imperial system mode is set, the program proceeds to step S130. In step S130, the monitor controller 160 executes the Imperial mode display processing by which display of various kinds of physical quantities is controlled according to the Imperial system.

As shown in FIG. 7, in step S135, the monitor controller 160 converts the various kinds of physical quantities according to the equations (1) to (4) below.

Ly=k1×Lm (1)

Fiy=K2×Fim (2)

Fay=K2×Fam (3)

Fry=k2×Frm (4)

In the equation (1), travel distance Lm [km] expressed in the metric system is converted into travel distance Ly [mile] in the Imperial system by multiplying the travel distance Lm [km] by a conversion coefficient K1=0.6214.

In the equation (2), the instant fuel consumption Fim [l/h] in the metric system is converted into the instant fuel consumption Fiy [gal/h] in the Imperial system by multiplying the instant fuel consumption Fim [l/h] by a conversion coefficient k2=0.2642.

In the equation (3), the average fuel consumption Fam [l/h] in the metric system is converted into the average fuel consumption Fay [gal/h] in the Imperial system by multiplying the average fuel consumption Fam [l/h] by a conversion coefficient k2=0.2642.

In the equation (4), the fuel level Frm [l] in the metric system is converted into the fuel level Fry [gal/h] in the Imperial system by multiplying the fuel level Frm [l] by a conversion coefficient k2=0.2642.

In step S141, the monitor controller 160 judges whether or not the physical quantity mode flag is 0. If a positive judgment is made in step S141, the program proceeds to step S142, while if a negative judgment is made in step S141, the program proceeds to step S143.

In step S142, like the step S112, the monitor controller 160 outputs an ON signal to predetermined segments of the numerical character segment group 180 and to the colon segment 182 in the numerical value display part 145 based on the information about the information of present time taken in step S101, and the program returns to step S101. The display screen of the second display part 142 is expressed as shown in FIG. 8A.

In step S143, the monitor controller 160 judges whether or not the physical quantity mode flag is 1. If a positive judgment is made in step S143, the program proceeds to step S145, while if a negative judgment is made in step S143, the program proceeds to step S147.

In step S145, like the step S115, the monitor controller 160 outputs an ON signal to each of the hourglass indicator 143a and the second D segment 147D. Furthermore, the monitor controller 160 outputs an ON signal to the predetermined segments of the numerical character segment group 180 and to the dot segment 181 in the numerical value display part 145 based on the information about the accumulated operating time T [h], and the program returns to step S101. The display screen of the second display part 142 is expressed as shown in FIG. 8B.

In step S147, the monitor controller 160 judges whether or not the physical quantity mode flag is 2. If a positive judgment is made in step S147, the program proceeds to step S149, while if a negative judgment is made in step S147, the program proceeds to step S151.

In step S149, the monitor controller 160 outputs an ON signal to each of the odo indicator 184 and the first B segment 146B and the first C segment 146C. Furthermore, the monitor controller 160 outputs an ON signal to each of predetermined segments of the numerical character segment group 180 in the numerical value display part 145 based on the information about the travel distance Ly [mile] calculated in step S135, and the program returns to step S101. The display screen of the second display part 142 is expressed as shown in FIG. 9B.

In step S151, the monitor controller 160 judges whether or not the physical quantity mode flag is 3. If a positive judgment is made in step S151, the program proceeds to step S153, while if a negative judgment is made in step S151, the program proceeds to step S159.

In step S153, the monitor controller 160 judges whether or not the fuel mold flag is 0. If a positive judgment is made in step S153, the program proceeds to step S155, while if a negative judgment is made in step S153, the program proceeds to step S157.

In step S155, the monitor controller 160 outputs an ON signal to each of the fuel indicator 143b and the second A segment 147A, the second B segment 147B, the second C segment 147C, and the second D segment 147D. Furthermore, the monitor controller 160 outputs an ON signal to each of the predetermined segments of the numerical character segment group 180 and the dot segment 181 in the numerical value display part 145 based on the information about the instant fuel consumption Fiy [gal/h] calculated in step S135, and the program returns to step S101. The display screen of the second display part 142 is expressed as shown in FIG. 10B.

In step S157, the monitor controller 160 outputs an ON signal to each of the fuel indicator 143b, the average value indicator 183, and the second A segment 147A, the second B segment 147B, the second C segment 147C, and the second D segment 147D. Furthermore, the monitor controller 160 outputs an ON signal to each of the predetermined segments of the numerical character segment group 180 and the dot segment 181 in the numerical value display part 145, and the program returns to step S101. The display screen of the second display part 142 is expressed as shown in FIG. 11B.

In step S159, the monitor controller 160 outputs an ON signal to each of the fuel indicator 143b and the second A segment 147A and the second B segment 147B. Furthermore, the monitor controller 160 outputs an ON signal to each of the predetermined segments of the numerical character segment group 180 and the dot segment 181 in the numerical value display part 145 based on the information about the fuel level Fay [gal] calculated in step S135. The display screen of the second display part 142 is expressed as shown in FIG. 12B.

Examples of change over operations of the display screen of the monitor 130 are explained. Note that in the following explanation, examples of changeover operations of units displayed in the first unit display part 146 and the second unit display part 147 are explained, but explanation on the changeover operations of display content of the numerical value display part is omitted.

When “km” is displayed in the first unit display part 146 as shown in FIG. 9A (step S119) and if the unit system changeover switch 133 is operated, “mile” is displayed in the first unit display part 146 as shown in FIG. 9B (step S149). When “mile” is displayed in the first unit display part 146 (step S149) and if the unit system changeover switch 133 is operated, “km” is displayed in the first unit system display part 146 (step S119).

That is, the monitor controller 160 is configured to be able to select one of the unit “km” and the unit “mile” and to display the selected one, and the monitor controller 160 can be said to perform the following processing. The monitor controller 160 uses in common the symbol segment 146B that indicates symbol “m” out of the three symbol segments 146A, 146B, and 146C. The monitor controller 160 creates either one of the unit “km” or the unit “mile” on the display screen by selecting one of the remaining symbol segments, i.e., the symbol segment 146A that indicates symbol “k” and the symbol segment 146C that indicates “ile”.

When “l/h” is displayed in the second unit display part 147 as shown in FIG. 10A (step S125) and if the unit system changeover switch 133 is operated, “gal/h” is displayed in the second unit display part 147 as shown in FIG. 10B (step S155). When “gal/h” is displayed in the second unit display part 147 (step S155) and if the unit system changeover switch 133 is operated, “l/h” is displayed in the second unit display part 147 as shown in FIG. 10A (step S125).

That is, the monitor controller 160 is configured such that it can select one of the unit “l/h” and the unit “gal/h” when displaying the unit of instant fuel consumption, and the monitor controller can be said to perform the following processing.

The monitor controller 160 uses in common the symbol segments 147B, 147C and 147D that indicate symbols “l”, “/”, and “h”, respectively, out of the four symbol segments 147A, 147B, 147C, and 147D. The monitor controller 160 either creates the unit “gal/h” on the display screen by selecting the remaining symbol segment 147A that indicates symbol “ga”, or creates the unit “l/h” on the display screen by causing the remaining symbol segment 147A that indicates “ga” not to be selected, so that it is not displayed. Note that, display of the unit of average fuel consumption is performed in the same manner as the unit of the instant fuel consumption (cf., FIGS. 11A and 11B).

When “l” is displayed in the second unit display part 147 as shown in FIG. 12A (step S129) and if the unit system changeover switch 133 is operated, “gal” is displayed in the second unit display part 147 as shown in FIG. 12B (step S159). When “gal” is displayed in the second unit display part 147 and if the unit system changeover switch 133 is operated, then “l” is displayed in the second unit display part 147 (step S129).

That is, the monitor controller 160 is configured such that it can select one of the unit “l” and the unit “gal” when displaying the unit of instant fuel consumption, and the monitor controller 160 can be said to perform the following processing. The monitor controller 160 uses in common the symbol segment 147B that indicates the symbol “l” out of the four symbol segments 147A, 147B, 147C and 147D. The monitor controller 160 causes the symbol segment 147C that indicates the symbol “/” and the symbol segment 147D that indicates the symbol “h” not to be used, so that they are not displayed. The monitor controller 160 either creates the unit “gal” on the display screen by selecting the remaining symbol segment 147A that indicates the symbol “ga”, or creates the unit “l” on the display screen by causing the remaining symbol segment 147A that indicates “ga” not to be selected, so that it is not displayed.

According to the first embodiment explained above, the following operations and advantageous effects can be obtained.

(1) The display device for a vehicle includes the first unit display part 146, in which the unit [km] and the unit [mile] that represent travel distance coexist, with one symbol segment 146B (symbol “m”) being used in common. The first unit display part 146 includes, as three symbol segments that make up the unit [km] and the unit [mile], the symbol segment 146A that indicates “k”, the symbol segment 146B that indicates “m”, and the symbol segment 146C that indicates “ile”. The monitor controller 160 causes the symbol segment 146B that indicates “m” out of the three symbol segments to be used in common and one of the other two symbol segments to be selected and used in combination to create units “km” and “mile”, causes the selected symbol segment to be displayed in the first unit display part 146, and causes a numerical value that represents a travel distance corresponding to the selected unit to be displayed in the numerical value display part 145. As a result, the display area of the display unit of the display device of the invention can be made smaller than that of a display device that is provided with the segment “km” and the segment “mile” separately. Note that it is unnecessary to change the size of the segments, so that visibility is not aggravated.

Similarly, the display device includes the second unit display part 147, in which the unit [l/h] and the unit [gal/h] that represent instant fuel consumption coexist, with three symbol segments, i.e., the symbol segment 147B (symbol “l”), the symbol segment 147C (symbol “/”), and the symbol segment 147D (symbol “h”) being used in common. The second unit display part 147 includes, as four symbol segments that represent symbols making up the unit [l/h] and the unit [gal/h], the symbol segment 147A that indicates the symbol “ga”, the symbol segment 147B that indicates the symbol “l”, the symbol segment 147C that indicates the symbol “/”, and the symbol segment 147D that indicates the symbol “h”. The monitor controller 160 causes the symbol segment 147B that indicates the symbol “l”, the symbol segment 147C that indicates the symbol “/”, the symbol segment 147D that indicates the symbol “h” out of the four segment symbols to be used in common, causes a judgment to be made as to whether or not the segment 147A that indicates the symbol “ga” is to be selected to select one of the units “l/he” and “gal/h”, causes the symbol segment that represents the selected unit to be displayed in the second unit display part 147, and causes a numerical value that represents instant fuel consumption corresponding to the selected unit to be displayed in the numerical value display part 145. As a result, the display area of the display unit of the display device of the invention can be made smaller than that of a display device that is provided with the segment “l/h” and the segment “gal/h” separately. Note that the monitor controller 160 may be configured to cause the unit and numerical value that represents average fuel consumption to be displayed in the second unit display part 147.

Furthermore, the monitor controller 160 can cause two symbol segments out of the four symbol segments described above, i.e., the symbol segment 147A that indicates the symbol “ga” and the symbol segment 147B that indicates the symbol “l” to be used, causes the other symbol segments, i.e., the symbol segment 147C that indicates “/” and the symbol segment 147D that indicates the symbol “h” not to be displayed, causes the symbol segment 147B (symbol “l”) out of the two symbol segments 147A and 147B to be used in common, causes a judgment to be made as to whether or not the symbol segment 147A (symbol “ga”) is to be used to select and display the unit “l” or the unit “gal”, and causes a numerical value that represents fuel level corresponding to the selected unit to be displayed in the numerical value display part 145. As a result, the display area of the display unit in the display device of the invention can be made smaller than that of a display device provided with the segment “l” and the segment “gal” separately.

(2) A configuration is adopted such that when a unit in the metric system is displayed in either one of the first unit display part 146 or the second unit display part 147 and if the unit system changeover switch 133 is operated, the monitor controller 160 causes the unit in the metric system displayed in any of the first unit display part 146 and the second unit display part 147 to be changed over to the unit of the Imperial system and to be displayed. Because of the configuration in which when a unit is displayed and if the unit system changeover switch 133 is operated, the unit system is changed over, the operator can change over the unit system while he views the display screen of the monitor 130.

(3) A configuration is adopted such that in case when either one of the metric system mode or the Imperial system mode is set and if the physical quantity selection switch 131 is operated to change over display of the second display part 142 from one physical quantity to another physical quantity, the unit corresponding to the set mode is caused to be displayed in either one of the first unit display part 146 or the second unit display part 147. For example, when the travel distance is displayed in the metric system in the second display part 142 and if the physical quantity selection switch 131 is operated, “l/h” is displayed in the second unit display part 147 instead of “km” that is displayed in the first unit display part 146. That is, in a state in which the metric unit system is maintained, the numerical value and the unit of a physical quantity to be displayed is changed over to a different numerical value and a different unit of the physical quantity. For this reason, it is unnecessary for the operator to change the unit system each time when he changes the physical quantity to be displayed.

The following variations are within the scope of the present invention and one or a plurality of variation examples may be combined with the embodiment described above.

### Variation Example

In the embodiment described above, an example is explained in which “km” or “mile” is expressed by controlling the display/non-display states of the symbol segments 146A, 146B, and 146C in the first unit display part 146 and “l/h”, “gal/h”, “l”, “gal”, and “h” can be expressed by controlling the display/non-display state of the symbol segments 147A, 147B, 147C, and 147D in the second unit display part 147. However, the present invention is not limited thereto.

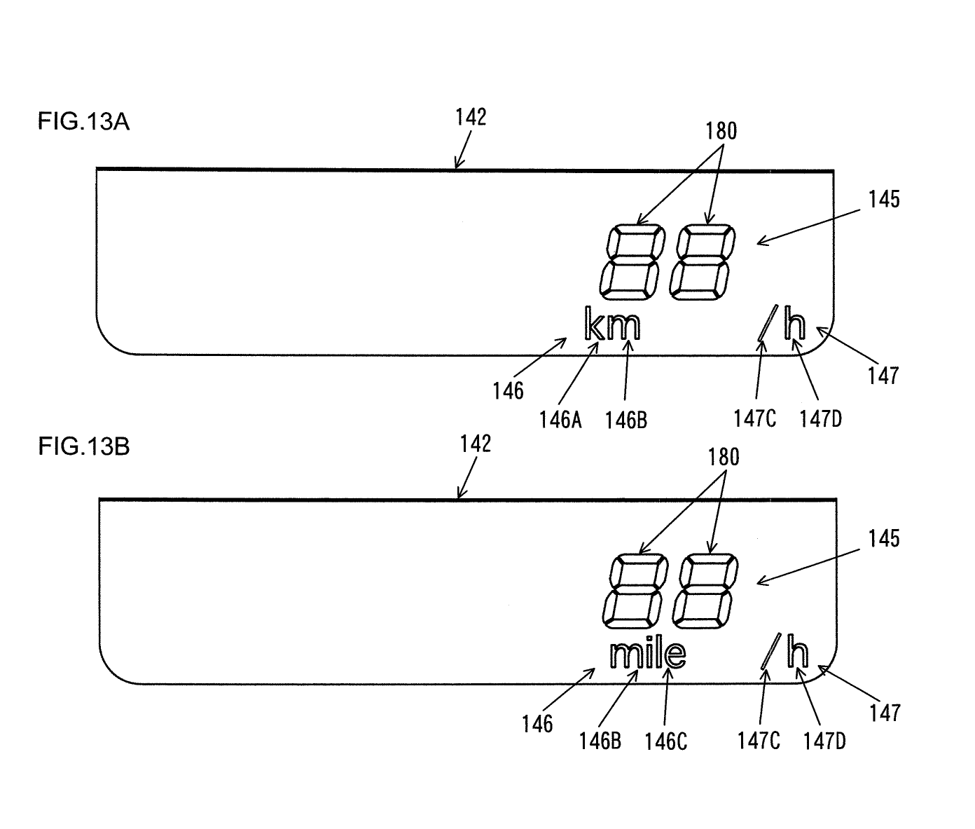

By causing the first A segment 146A and the first B segment 146B included in the first unit display part 146 and the second C segment 147C and the second D segment 147D included in the second unit display par 147 to be displayed in combination, the metric system unit [km/h] that represents vehicle speed can be formed as shown in FIG. 13A. Furthermore, by causing the first B segment 146B and the first C segment 146C in the first unit display part 146 and the second C segment 147C and the second D segment 147D in the second unit display part 147 to be displayed in combination, the Imperial system unit “mile/h” that represents vehicle speed can be displayed. In this manner, by causing a symbol segment included in the first unit display part 146 representing distance and symbol segments included in the second unit display part 147 representing fuel efficiency, fuel amount and time to be displayed in combination, a physical quantity that is different from the physical quantities that are represented by the first unit display part 146 and the second unit display part 147 respectively, can be formed. As a result, the display area of the display unit can be further decreased. When vehicle speed is caused to be displayed by using the second display part 142, the speed display part in the first display part 141 shown in FIG. 3 can be omitted.

### Variation Example 2

In the embodiment described above, an example is explained in which present time, accumulated operating time, travel distance, instant fuel consumption, average fuel consumption, and fuel level are displayed in the second display part 142. However, the present invention is not limited thereto. A configuration may be adopted such that information about various physical quantities is displayed. For example, a fuel use amount may be displayed instead of fuel level (fuel residual amount).

It may be satisfactory that the display device for a vehicle is configured to display at least one kind of physical quantity. For example, the display device may be provided with only the first unit display part 146 that displays only travel distance.

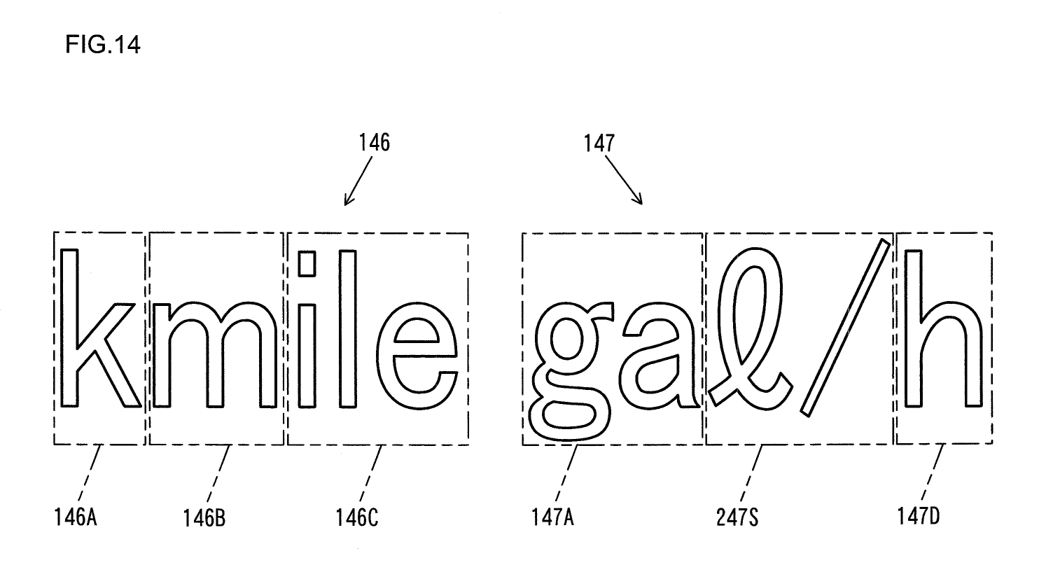

Furthermore, a configuration may be adopted such that in the second unit display part 147, instant fuel consumption and average fuel consumption are caused to be displayed but fuel level is not caused to be displayed. In this case, as shown in FIG. 14, “l” and “/(slash)” are made up by a single segment 247S, so that the number of segments can be decreased as compared with the embodiment described above.

### Variation Example 3

In the embodiment described above, an example is explained in which the unit “km” and the unit “mile” that represent travel distance coexist. It may be configured such that the unit “m” that represents travel distance is further added to coexist, so that only the first B segment 146B that represents “m” is caused to be displayed in response to a predetermined operation. That is, the unit display part may be any one in which two or more units that represent a single kind of physical quantity coexist.

### Variation Example 4

In the embodiment described above, an example is explained in which each time when the physical quantity selection switch 131 is operated, the information about the physical quantity to be displayed in the second display part 142 is changed over in the order of present time (clock), accumulated operating time, travel distance, fuel consumption (instant/average), and fuel level. However, the present invention is not limited thereto. Also, a configuration may be adopted, in which selection switches representing various kinds of information are provided individually and when a predetermined selection switch is operated, the corresponding information is displayed in the second display part 142.

### Variation Example 5

In the embodiment described above, an example of configuration is explained, in which for each of the first unit display part 146 and the second unit display part 147, the Imperial system unit and the metric system unit coexist. However, the present invention is not limited thereto. The unit display part may be configured such that a unit of the SI unit system and a unit of the CGS unit system coexist therein.

### Variation Example 6

In the embodiment described above, a wheeled loader is explained as an example of the vehicle. However, the present invention is not limited thereto. The vehicle may be another special motor vehicle, for example, a wheeled excavator, a forklift, a telescopic handler (or telehandler), a lift truck, or the like, or the vehicle may be an ordinary vehicle, a compact car, a light car or the like.

As far as the features of the present invention are not damaged, the present invention is not limited to the embodiments described above and other embodiments conceivable within the technical concept of the present invention are included in the scope of the present invention. The embodiments and variation examples explained above may be combined with each other as appropriate.

What is claimed is:

1. A display device for a vehicle, comprising:
a display unit that displays at least one kind of physical quantity; and
a display control unit that causes the display unit to display the at least one kind of physical quantity, wherein:
the display unit includes a numerical value display part that displays a numerical value of a plurality of digits and a unit display part, in which a plurality of units representing the at least one kind of physical quantity coexist;
the numerical value display part has a numerical character segment group representing a numerical character in each of the plurality of digits;
the unit display part has a plurality of symbol segments representing symbols making up the plurality of units; and
the display control unit selects one of the plurality of units, causes symbol segments that represent a selected unit to be displayed in the unit display part, and causes a numerical value representing the at least one kind of physical quantity corresponding to the selected unit to be displayed in the numerical value display part.

2. A display device for a vehicle according to claim 1, wherein
the display control unit causes one unit to be displayed as another unit that is different from the one unit by using in common one or more of the plurality of symbol segments in the unit display part.

3. A display device for a vehicle according to claim 1, further comprising:
a changeover switch for switching over one unit that is displayed in the unit display part to another unit that is different from the one unit, wherein
when the one unit is displayed in the unit display part and if the changeover switch is operated, the display control unit causes the one unit displayed in the unit display part to be changed over to the other unit that is different from the one unit and to be displayed.

4. A display device for a vehicle according to claim 3, wherein:
the unit display part is provided for each of a plurality of kinds of physical quantities;
the display device further comprises a physical quantity selection switch that selects one physical quantity to be displayed in the display unit out of the plurality of kinds of physical quantities;
the display control unit, when the one physical quantity is selected with the physical quantity selection switch, causes a numerical value that represents the selected one physical quantity to be displayed in the numerical value display part and causes a unit that represents the selected one physical quantity to be displayed in the unit display part;
in the unit display part, a unit of metric system and a unit of Imperial system coexist;
the display control unit has a unit system selection part that sets either one of a metric system mode in which the unit of metric system is displayed in the unit display part and an Imperial system mode in which the unit of Imperial system is displayed in the unit display part in response to an operation of the changeover switch; and
in case when either one of the metric system mode or the Imperial system mode is set and if the physical quantity selection switch is operated to change over a display of the display unit from one physical quantity to another physical quantity, the display control unit causes a unit corresponding to a mode set by the unit system selection unit to be displayed in the unit display part.

5. A display device for a vehicle according to claim 1, wherein:
the unit display part is provided for each of a plurality of kinds of physical quantities; and
the display control unit causes at least a symbol segment included in one unit display part and a symbol segment included in another unit display part to be displayed in combination to form a unit representing a physical quantity different from a physical quantity represented by each of the one unit display part and the other unit display part.

6. A display device for a vehicle according to claim 2, further comprising:
a changeover switch for switching over one unit that is displayed in the unit display part to another unit that is different from the one unit, wherein
when the one unit is displayed in the unit display part and if the changeover switch is operated, the display control unit causes the one unit displayed in the unit display part to be changed over to the other unit that is different from the one unit and to be displayed.

7. A display device for a vehicle according to claim 6, wherein:
the unit display part is provided for each of a plurality of kinds of physical quantities;
the display device further comprises a physical quantity selection switch that selects one physical quantity to be displayed in the display unit out of the plurality of kinds of physical quantities;
the display control unit, when the one physical quantity is selected with the physical quantity selection switch, causes a numerical value that represents the selected one physical quantity to be displayed in the numerical value display part and causes a unit that represents the selected one physical quantity to be displayed in the unit display part;
in the unit display part, a unit of metric system and a unit of Imperial system coexist;
the display control unit has a unit system selection part that sets either one of a metric system mode in which the unit of metric system is displayed in the unit display part and an Imperial system mode in which the unit of Imperial system is displayed in the unit display part in response to an operation of the changeover switch; and
in case when either one of the metric system mode or the Imperial system mode is set and if the physical quantity selection switch is operated to change over a display of the display unit from one physical quantity to another physical quantity, the display control unit causes a unit corresponding to a mode set by the unit system selection unit to be displayed in the unit display part.

8. A display device for a vehicle according to claim 2, wherein:
the unit display part is provided for each of a plurality of kinds of physical quantities; and
the display control unit causes at least a symbol segment included in one unit display part and a symbol segment included in another unit display part to be displayed in combination to form a unit representing a physical quantity different from a physical quantity represented by each of the one unit display part and the other unit display part.

9. A display device for a vehicle according to claim 3, wherein:
the unit display part is provided for each of a plurality of kinds of physical quantities; and
the display control unit causes at least a symbol segment included in one unit display part and a symbol segment included in another unit display part to be displayed in combination to form a unit representing a physical quantity different from a physical quantity represented by each of the one unit display part and the other unit display part.
